(19) United States
(12) Patent Application Publication
(10) Pub. No.: US 2024/0124703 A1
(43) Pub. Date: Apr. 18, 2024

(54) RESIN COMPOSITION FOR IMPACT ABSORPTION

(71) Applicant: KOATSU GAS KOGYO CO., LTD., Osaka (JP)

(72) Inventors: Takeshi SANO, Osaka (JP); Takashi YAMAGUCHI, Osaka (JP); Tatsuya NOIRI, Osaka (JP)

(21) Appl. No.: 18/547,143

(22) PCT Filed: Dec. 27, 2021
(86) PCT No.: PCT/JP2021/048661

§ 371 Date: Aug. 18, 2023

(30) Foreign Application Priority Data
Feb. 24, 2021 (JP) 2021-027473

(51) Int. Cl. C08L 53/00; F16F 7/00

(52) U.S. Cl. CPC C08L 53/00; F16F 7/00; C08L 2205/035; C08L 2207/324; F16F 2224/025

(57) ABSTRACT

There is provided a shock absorption-resin composition comprising: an A component comprising one or more block copolymers each comprising a polymer component A₁ having a glass transition point of 30° C. or higher and a polymer component A₂ having a glass transition point of 0° C. or lower; a B component comprising a polymer compatible with the polymer component A₁; a C component comprising a filler compatible with the B component or dispersible in the B component; and a D component comprising a liquid polyol-based component.

### TECHNICAL FIELD

The present invention relates to a shock absorption-resin composition for protecting a device from shock.

### BACKGROUND ART

With the spread of smartphones, tablets, and the like, not only miniaturization and weight reduction of devices but also weight reduction and thickness reduction of shock-absorbing sheets for protecting devices from shock are requested.

As a shock-absorbing sheet, a vibration proof rubber made of a vulcanized rubber such as a butyl rubber or a synthetic rubber such as a silicone rubber has conventionally been used, but in recent years, damping materials that can be expected to have high damping performance and reduced production cost have been studied. Damping materials are known that convert vibration energy into thermal energy and utilize viscoelasticity of a high molecular-weight compound. The damping of vibration by a high molecular-weight compound utilizes a function of converting vibration energy from the outside into thermal energy and releasing the thermal energy to the outside to cause loss of vibration energy. However, conventional high molecular-weight compound-based damping materials need to have a thickness of at least about several millimeters in order to exhibit their damping performance, and there is a problem that if the thickness is made thinner than that, sufficient damping performance cannot be exhibited.

As a measure for this problem, the present applicant has proposed a shock absorption-resin composition which comprises a block copolymer containing a hard segment and a soft segment and can provide superior shock absorbability even when the resin composition is thinned (Patent Document 1).

### PRIOR ART DOCUMENT

### Patent Document

Patent Document 1: JP-A-2015-145484

### SUMMARY OF THE INVENTION

### Problems to be Solved by the Invention

However, with further reduction in size and weight of devices, further improvement in damping performance is also requested for shock-absorbing sheets that protect devices from shock.

In view of such circumstances, an object of the present invention is to provide a shock absorption-resin composition having further improved damping performance.

### Solutions to the Problems

As a result of intensive studies for solving the above problems, the present inventors have found that blending a liquid polyol-based component makes it possible to greatly improve shock absorbability, thereby accomplishing the present invention. That is, the shock absorption-resin composition of the present invention is characterized by comprising: an A component comprising one or more block copolymers each comprising a polymer component A₁ having a glass transition point of 30° C. or higher and a polymer component A₂ having a glass transition point of 0° C. or lower; a B component comprising a polymer compatible with the polymer component A₁; a C component comprising a filler compatible with the B component or dispersible in the B component; and a D component comprising a liquid polyol-based component.

### Effects of the Invention

The shock absorption-resin composition of the present invention has superior shock absorbability even when it is thinned.

### BRIEF DESCRIPTION OF THE DRAWINGS

FIG. 1 is a graph showing a comparison relationship between a thickness and a shock absorption rate of a sheet made of a resin composition in Example 1, Comparative Example 1, and Comparative Example 2.

FIG. 2 is a graph showing a comparison relationship between a thickness and a shock absorption rate of a sheet made of a resin composition in Example 4, Comparative Example 7, and Comparative Example 8.

FIG. 3 is a graph showing a comparison relationship between a thickness and a shock absorption rate of a sheet made of a resin composition in Example 5, Comparative Example 9, and Comparative Example 10.

### DETAILED DESCRIPTION

Hereinafter, embodiments of the present invention will be described in detail.

The shock absorption-resin composition of the present invention is characterized by comprising: an A component comprising a block copolymer comprising a polymer component A₁ having a glass transition point of 30° C. or higher and a polymer component A₂ having a glass transition point of 0° C. or lower; a B component comprising a polymer compatible with the polymer component A₁; a C component comprising a filler compatible with the B component or dispersible in the B component; and a D component comprising a liquid polyol-based component.

(A Component)

The A component to be used in the present invention is a block copolymer comprising a polymer component A₁ (hard segment) having a glass transition point of 30° C. or higher and a polymer component A₂ (soft segment) having a glass transition point of 0° C. or lower. The arrangement of the polymer component A₁ and the polymer component A₂ is not particularly limited, and any arrangement may be adopted. For example, it can be represented by (A₁-A₂)p, (A₁-A₂-A₁)q, or (A₂-A₁-A₂)r. Here, p, q, and r are arbitrary integers.

Examples of the polymer constituting the polymer component A₁ include a styrene-based resin, a poly(meth)acrylate resin, a polyamide resin, and a polyester resin which are polymers having a glass transition point of 30° C. or higher. Examples of the styrene-based resin include polystyrene, polychlorostyrene, and poly-α-methylstyrene, and polystyrene (Tg=80 to 100° C.) is preferable. Examples of the poly(meth)acrylate resin include polymethyl methacrylate (Tg=72 to 105° C.), polyethyl methacrylate (Tg=65° C.), and poly-t-butyl methacrylate (Tg=107° C.). Examples of the polyamide resin include polyamide 6 (Tg=50° C.), polyamide 66 (Tg=50° C.), and polyamide 610 (Tg=50° C.). Examples of the polyester resin include polyethylene terephthalate (Tg=80° C.), polybutylene terephthalate (Tg=37 to 53° C.), and polyethylene naphthalate (Tg=113° C.).

The polymer component A₂ is a polymer having a glass transition point of 0° C. or lower, and can be selected according to the polymer component A₁. For example, polyisoprene, polyvinylisoprene, polybutadiene, and their hydrogenated products such as poly(ethylene-propylene) and poly(ethylene-butylene) can be recited for polystyrene. Polybutyl acrylate can be recited for polymethyl methacrylate. Polyesters and polyethers can be recited for polyamides. In addition, aliphatic polyesters and polyethers can be recited for aromatic polyesters.

Specific examples of the A component include, but are not particularly limited to, styrene-based block copolymers such as a styrene-isoprene-styrene block copolymer, a styrene-vinylisoprene-styrene block copolymer, and a styrene-butadiene-styrene block copolymer, hydrogenated products thereof, and a methyl methacrylate-butyl acrylate-methyl acrylate resin.

In the present invention, for example, the following commercially available block copolymers can be used.

(1) Styrene-isoprene-styrene Block Copolymer (Abbreviated as “SIS”)
KRATON D manufactured by Kraton Corporation, JSR SIS manufactured by JSR Corporation, and Quintac manufactured by ZEON Corporation

(2) Styrene-butadiene-styrene Block Copolymer (Abbreviated as “SBS”)
KRATON D manufactured by Kraton Corporation, TUFPRENE manufactured by Asahi Kasei Corporation, and ASAPRENE T manufactured by Asahi Kasei Corporation

(3) Styrene-(ethylene-propylene)-styrene Block Copolymer (Abbreviated as “SEPS”) (Hydrogenated Product of SIS)
KRATON G manufactured by Kraton Corporation and SEPTON 2000 series manufactured by Kuraray Co., Ltd.

(4) Styrene-(ethylene-butylene)-styrene Block Copolymer (Abbreviated as “SEBS”) (Hydrogenated Product of SBS)
KRATON G manufactured by Kraton Corporation, Tuftec H manufactured by Asahi Kasei Corporation, and SEPTON 8000 series manufactured by Kuraray Co., Ltd.

(5) Styrene-butadiene-butylene-styrene Block Copolymer (Abbreviated as “SBBS”)
Tuftec P manufactured by Asahi Kasei Corporation

(6) Styrene-Ethylene-(Ethylene-Propylene)-Styrene Block Copolymer (Abbreviated as “SEEPS”)
SEPTON 4000 series manufactured by Kuraray Co., Ltd.

(8) Styrene-vinyl polyisoprene-styrene Block Copolymer
HYBRAR manufactured by Kuraray Co., Ltd.

(9) Methyl methacrylate-butyl acrylate-methyl Methacrylate Triblock Copolymer
KURARITY 2000 series, 3000 series, and 4000 series manufactured by Kuraray Co., Ltd., and Nanostrength manufactured by ARKEMA

(10) Methyl methacrylate-butyl Acrylate Diblock Copolymer
KURARITY 1000 series manufactured by Kuraray Co., Ltd.

In addition, products obtained by modifying a carboxyl group, a hydroxy group, an epoxy group, a maleic anhydride group or the like of the copolymers (1) to (6) recited above can also be used.

As the A component, two or more substances may also be used. By combining two or more substances, flexibility and toughness can be adjusted. The combination is not particularly limited. Examples thereof include a combination of a methyl methacrylate-butyl acrylate-methyl methacrylate triblock copolymer and a methyl methacrylate-butyl acrylate diblock copolymer.

(B Component)

The B component is a polymer having compatibility with the polymer component A₁. In the present invention, the phrase that the B component has compatibility with the polymer component A₁ means that a homopolymer of the polymer component A₁ and the B component can be mixed to form a film and the resulting film is transparent when visually observed at room temperature.

The B component may be selected according to the type of the polymer component A₁. For example, when the styrene-based resin is used as the polymer component A₁, an aromatic hydrocarbon resin, a hydrogenated product of an aromatic hydrocarbon resin, an alicyclic hydrocarbon resin, and copolymerized resins thereof can be used as the B component. Alternatively, an aromatic hydrocarbon oligomer, an aliphatic cyclic hydrocarbon oligomer, and copolymerized oligomers thereof may be used. In the present invention, the term “oligomer” refers to any compound having a degree of polymerization of 10 or less. The aromatic hydrocarbon resin is a compound constituted of a benzene ring and/or a plurality of fused rings, and examples thereof include homopolymers of styrene or a substituted styrene such as α-methylstyrene, t-butylstyrene, or vinyltoluene, and modified products thereof. The hydrogenated product of an aromatic hydrocarbon resin is a compound constituted of a benzene ring and/or a plurality of fused rings, and examples thereof include hydrogenated products of homopolymers of styrene or a substituted styrene such as α-methylstyrene, t-butylstyrene, or vinyltoluene. Examples of the alicyclic hydrocarbon resin include a hydrogenated product of an aromatic resin and a cyclohexyl methacrylate resin. The copolymerized resin is a copolymerized product of an aromatic resin or an alicyclic resin, and an aliphatic resin. The B component is preferably an aromatic hydrocarbon resin, more preferably a homopolymer of styrene or a modified product thereof or a hydrogenated product thereof. The modified product is preferably an oxazoline group-containing polystyrene.

When the poly(meth)acrylate resin is used as the polymer component A₁, an aliphatic hydrocarbon resin can be used as the B component. As the aliphatic hydrocarbon resin, a polyolefin resin, a poly(meth)acrylate resin, and modified products thereof can be used. A poly(meth)acrylate resin or a modified product thereof is preferable. The modified product is a product obtained by modifying a carboxyl group, a hydroxy group, an epoxy group, a maleic anhydride group, or the like. The weight average molecular weight of the poly(meth)acrylate resin or a modified product thereof is preferably 10,000 or less.

When the polyamide resin is used as the polymer component A₁, an aromatic or alicyclic resin containing an epoxy group or an oxazoline group can be used as the B component.

When the polyester resin is used as the polymer component A₁, an aromatic or alicyclic resin containing an epoxy group or an oxazoline group can be used as the B component.

In the present invention, as the B component, for example, the following commercially available resins can be used.

(Aromatic Hydrocarbon Resin)

(1) Styrene-Based Resin
FTR manufactured by Mitsui Chemicals, Inc., YS RESIN SX manufactured by Yasuhara Chemical Co., Ltd., and ARUFON UP-1150 manufactured by Toagosei Co., Ltd.

(2) Aromatic Petroleum Resin
Nisseki Neopolymer, which is an aromatic petroleum resin manufactured by ENEOS Corporation, PETCOAL, which is a petroleum resin manufactured by Tosoh Corporation, and NIKANOL, which is a xylene resin manufactured by Fudow Co., Ltd.

(3) Aromatic Modified Resin
PETROTACK, which is a petroleum resin manufactured by Tosoh Corporation, and EPOCROS RPS-1005, which is an oxazoline group-containing reactive polystyrene manufactured by Nippon Shokubai Co., Ltd.

(4) Aromatic Oil
Nisseki Hi-Sol manufactured by ENEOS Corporation and Diana Process Oil AC manufactured by Idemitsu Kosan Co., Ltd.

(Alicyclic Hydrocarbon Resin)

(5) Naphthenic Oil
Diana Process Oil NP series and NS series manufactured by Idemitsu Kosan Co., Ltd.

(Poly(meth)acrylate Resin)

(1) Polymethacrylate Resin
ACRYPET manufactured by Mitsubishi Chemical Corporation and PARAPELLET manufactured by Kuraray Co., Ltd.

(2) Polyacrylate Resin
NeoCryl, which is a solid acrylic resin manufactured by Kusumoto Chemicals, Ltd. and ARUFON UP-1000 series, which is a non-functional acrylic polymer manufactured by Toagosei Co., Ltd.

(3) Polyacrylate Modified Resin
ARUFON UC-2000 series, which is a hydroxy group-containing acrylic polymer manufactured by Toagosei Co., Ltd., ARUFON UC-3000 series, which is a carboxyl group-containing acrylic polymer, and ARUFON UC-4000 series, which is an epoxy group-containing acrylic polymer. ACTFLOW 1000 series, which is a hydroxy group-containing acrylic polymer, and ACTFLOW 3000 series, which is a carboxyl group-containing acrylic polymer, both manufactured by Soken Chemical & Engineering Co., Ltd.

As the B component, a polymer that reacts with a filler can be used. As a result of reacting with the filler, the B component and the filler C are facilitated to more easily exist integrally with the B component in a region where a hard segment exists, that is, in a so-called hard segment domain, and thus the damping performance in the hard segment domain can be further improved. Examples of the B component that reacts with the filler include the oxazoline group-containing reactive polystyrene described above. An oxazoline group reacts with a carboxylic acid group, a hydroxy group, and a thiol group of the filler. Another example of the B component may be a polymer modified with an epoxy group, a carboxylic acid group, a hydroxy group, or the like.

(C Component)

The C component to be used in the present invention is a filler, and is a compound having two or more cyclic structures selected from the group consisting of an aromatic hydrocarbon, an aliphatic cyclic hydrocarbon, and a heteroaromatic hydrocarbon, or a metal salt of the compound. Here, the “two or more cyclic structures” refers to two or more monocyclic compounds bonded directly or with a linking group interposed therebetween, a fused polycyclic compound in which two or more monocyclic rings are fused, a bridged cyclic compound, and a spiro polycyclic compound. Hereinafter, unless otherwise specified, a fused polycyclic compound, a bridged cyclic compound, and a spiro polycyclic compound are referred to as polycyclic compounds.

The compound having two or more cyclic structures includes not only a low molecular-weight compound but also a high molecular-weight compound. For example, when the high molecular-weight compound is a homopolymer, repeating units may contain a polymer of two or more monocyclic compounds bonded directly or with a linking group interposed therebetween, and repeating units may contain a polymer of one or more monocyclic compounds and one polycyclic compound bonded directly or with a linking group interposed therebetween. When the high molecular-weight compound is a copolymer, the repeating units of each component of the copolymer as the high molecular-weight compound may contain any one compound selected from the group consisting of one monocyclic compound, a compound in which two or more monocyclic compounds are bonded directly or with a linking group interposed therebetween, and one polycyclic compound.

Here, as the linking group that links two or more monocyclic compounds, one selected from the group consisting of —O—, —S—, —P—, —NH—, —NR— (R is an alkyl group having 1 to 4 carbon atoms), —Si—, —COO—, —CONH—, —(CH₂)ₙ— (n is an integer of 1 to 12), —CH═CH—, and —C≡C— can be used. As to —(CH₂)ₙ—, when n is 2 or more, at least one of the methylene groups may be replaced by —O—, —S—, —P—, —NH—, —NR— (R is an alkyl group having 1 to 4 carbon atoms), —Si—, —COO—, —CONH—, —CH═CH—, or —C≡C—.

Examples of the compound having two or more cyclic structures selected from aromatic hydrocarbons include biphenyl, diphenylamine, triphenylamine, and methylene bisphenol, in which benzene as a monocyclic compound are bonded directly or with a linking group interposed therebetween and which may have a substituent. Examples of the polycyclic compound include naphthalene, anthracene, phenanthrene, tetrahydronaphthalene, 9,10-dihydroanthracene, and acetonaphthalene, which may have a substituent.

Examples of the compound having two or more cyclic structures selected from aliphatic cyclic hydrocarbons include compounds in which molecules of cyclohexane, cyclopentane, cyclopropane, cyclobutane, isobornyl, which are monocyclic compounds, or cyclohexene, cyclopentene, cyclopropene, or cyclobutene, which have a double bond in the ring, are bonded directly or with a linking group interposed therebetween. In addition, examples of the polycyclic compound include monocyclo bodies, dicyclo bodies, tricyclo bodies, tetracyclo bodies, and pentacyclo bodies having 5 or more carbon atoms, which may have a substituent, and specifically include dicyclopentenyl and norbornenyl. The aliphatic cyclic hydrocarbon includes alicyclic terpenes as well, such as α-pinene, β-pinene, limonene, caffeine, an abietic acid group, terpinolene, terpinene, phellandrene, α-carotene, β-carotene, and γ-carotene. Terpene oil obtained from essential oil components of plants mainly containing those components, rosin obtained by purifying pine resin, and derivatives thereof are also included. Here, the derivative of rosin includes hydrogenated rosin or a rosin ester, disproportionated rosin, and the like, and is preferably hydrogenated rosin or a rosin ester.

Examples of the compound having two or more cyclic structures selected from heteroaromatic hydrocarbons include pyrrole, furan, thiophene, imidazole, maleimide, oxazole, thiazole, pyrazole, isoxazole, isothiazole, pyridine, pyridazine, pyrimidine, piperidine, piperazine, and morpholine, which are monocyclic compounds and may have a substituent. Examples of the polycyclic compound include benzofuran, isobenzofuran, benzothiophene, benzotriazole, isobenzothiophene, indole, isoindole, benzimidazole, benzothiazole, benzoxazole, quinazole, and naphthyridine, which may have a substituent.

Here, the two or more monocyclic compounds are not limited to the case of including only the same type of monocyclic compounds, and may include different types of monocyclic compounds. Examples of the substituent include a linear or branched alkyl group having 1 to 4 carbon atoms, a halogen atom, a cyano group, a hydroxy group, a nitro group, an alkoxy group, a carboxyl group, an amino group, and an amide group.

Examples of the metal salt of the compound having two or more cyclic structures include a sodium salt, a magnesium salt, a potassium salt, and a calcium salt.

Examples of the high molecular-weight compound or oligomer having two or more cyclic structures include the following. Examples of the homopolymer in which the repeating unit is two or more monocyclic compounds bonded directly or with a linking group interposed therebetween include terpene phenolic resin. In the case of a copolymer, for example, a coumarone-indene resin can be recited.

As the filler, a low molecular-weight compound or a high molecular-weight compound which reacts with the B component can also be used. As a result of reacting with the B component, the B component and the C component are facilitated to more easily exist integrally with the B component in a region where a hard segment exists, that is, in a so-called hard segment domain, and thus the damping performance in the hard segment domain can be further improved.

Examples of the filler that reacts with the B component include organic fillers containing a carboxyl group, an aromatic thiol group, a phenol group, or an alcohol group when the B component is an oxazoline group-containing reactive polystyrene. An oxazoline group reacts with a carboxyl group, an aromatic thiol group, a phenol group, and an alcohol group of a filler. Examples of the filler containing a carboxyl group include 4-phenylbenzoic acid and derivatives thereof, 1-naphthoic acid and derivatives thereof, and rosin containing an abietic acid group and derivatives thereof. Examples of the filler containing an aromatic thiol group include biphenyl-4-thiol and derivatives thereof, and 2-naphthalenethiol and derivatives thereof. Examples of the filler containing a phenol group include biphenyl-4-ol, and examples of the filler containing an alcohol group include 4-hydroxymethylbiphenyl. Further, as another example of the B component, an epoxy group-modified acrylic resin or a hydroxy group-modified acrylic resin into which a functional group such as an epoxy group or a hydroxy group is introduced can be recited. The filler is preferably a compound or high molecular-weight compound having two or more cyclic structures selected from aromatic hydrocarbons. More preferably, examples thereof include diphenylamine, triphenylamine, methylenebisphenol, and rosin derivatives, which may have a substituent.

When a poly(meth)acrylate resin is used as the polymer component A₁, an aliphatic hydrocarbon resin can be used as the B component, and a polymer in which repeating units are two or more monocyclic compounds bonded directly or with a linking group interposed therebetween can be used as the C component. One example of the C component is a polymer in which two or more homopolymers of styrene or a substituted styrene such as α-methylstyrene, t-butylstyrene, and vinyltoluene are bonded.

When a styrene-based resin is used as the polymer component A₁, an alicyclic hydrocarbon resin can be used as the B component, and a hydrogenated petroleum resin can be used as the C component. The hydrogenated petroleum resin is a substance obtained by hydrogenating a petroleum resin using a hydrogenation catalyst. The hydrogenation catalyst is a catalyst formed by supporting metal such as cobalt, copper, nickel, palladium, or platinum on a carrier such as silica, alumina, or silica alumina. The petroleum resin is not particularly limited, and can be classified into aliphatic petroleum resin, aromatic petroleum resin, cyclopentadiene-based petroleum resin, and the like. As the aliphatic petroleum resin, a C5-based petroleum resin or the like can be used. As the aromatic petroleum resin, a C9-based petroleum resin or the like can be used. The C5-based petroleum resin is obtained by cationically polymerizing a C5-based petroleum fraction, for example, pentene, methylbutene, isoprene, cyclopentene, or the like. As the C9-based petroleum resin, a resin obtained by cationically polymerizing a C9-based petroleum fraction obtained by cracking naphtha, such as styrene, vinyltoluene, or α-methylstyrene, can be used. The dicyclopentadiene-based petroleum resin is a resin obtained through thermal polymerization or cationic polymerization of dicyclopentadiene. These petroleum resins may have been modified with a polar group such as a hydroxy group or an ester group.

(D Component)

The D component to be used in the present invention is composed of a liquid polyol-based component. In the present invention, the shock absorption rate can be greatly improved by blending the D component. Here, the term “liquid” means having fluidity at room temperature (25° C.) and normal pressure (atmospheric pressure). In addition, the term “polyol-based component” refers to a general name for compounds containing two or more hydroxy groups in one molecule, and includes a polyether polyol, a polyester polyol, a modified product of a polyol, and the like. The liquid polyol-based component includes one or more selected from the group consisting of a liquid polyether polyol, a liquid polyester polyol, a copolymer of the polyether polyol and the polyester polyol, and a modified product of at least one of these. The modified product is at least one selected from the group consisting of a silyl group-containing polyol (that is, a silane-modified product), a phosphorus-containing polyol, a halogen-containing polyol, and a polar group-containing polyol. For example, as the modified product, a silyl group-containing polyol (that is, a silane-modified product) and a phosphorus-containing polyol may be selected. The polar group-containing polyol may have a hydroxy group, a carboxyl group, an ester group, a nitro group, and/or an amino group as a polar group. Examples of the liquid polyether polyol include polyalkylene glycols such as polyethylene glycol, polytrimethylene glycol, polypropylene glycol, polytetramethylene glycol, and polybutylene glycol. Polyethylene glycol, polytrimethylene glycol or polypropylene glycol is preferable, and polypropylene glycol is more preferable. Examples of the liquid polyether polyol include PREMINOL manufactured by AGC Inc. Examples of the liquid polyester polyol include polyphosphate ester polyol.

Examples of the silane-modified product of a liquid polyether polyol include polyether polymers having a hydrolyzable silyl group at the terminal of a polyalkylene glycol such as polyethylene glycol, polytrimethylene glycol, polypropylene glycol, polytetramethylene glycol, or polybutylene glycol. Examples of the silane-modified product of a liquid polyether polyol include EXCESTAR manufactured by AGC Inc., and MS Polymer and Silyl manufactured by KANEKA Corporation.

The liquid phosphorus-containing polyol is a polyol containing phosphorus in the molecule via a chemical bond. Examples of the phosphorus-containing polyol include, but are not particularly limited to, those having a phosphate group (phosphoric acid group) in a polyalkylene glycol, such as polyethylene glycol or polypropylene glycol. For example, Exolit OP500 series manufactured by Clariant Chemicals can be recited.

In the resin composition of the present invention, the A component accounts for 1 to 99% by weight, preferably 5 to 90% by weight, and more preferably 10 to 60% by weight of the entire resin composition. This is because when the content is less than 1% by weight, the film formability is deteriorated, and when the content is more than 99% by weight, the damping performance is deteriorated. The content of the B component is 0.5 to 90% by weight, preferably 1 to 50% by weight, and more preferably 10 to 40% by weight. When the content of the B component is less than 0.5% by weight, the clouding point is high, and when the content of the B component is more than 90% by weight, a resulting sheet is brittle, which is unfavorable. The content of the C component is 0.1 to 90% by weight, preferably 0.5 to 50% by weight, and more preferably 5 to 40% by weight. When the content of the C component is less than 0.1% by weight, the shock absorption rate described later decreases, and when the content is more than 90% by weight, a resulting sheet is brittle, which is unfavorable. The content of the D component is 0.3 to 30% by weight, preferably 5 to 20% by weight, and more preferably 10 to 20% by weight. When the content of the D component is less than 0.3% by weight, the shock absorption rate is not significantly improved, and when the content is more than 30% by weight, bleeding occurs, which is unfavorable.

In addition, various additives may be blended in the resin composition of the present invention as long as shock absorbability is not reduced. Examples of the additives include an antioxidant, an ultraviolet absorber, and a flame retardant.

(Production Method)

The resin composition of the present invention can be produced by mixing the A component with the B component, the C component, and the D component by melting and mixing by heating or dissolving and mixing using a solvent. For example, in order to make the C component compatible with the B component or to disperse the C component in the B component, a method of mixing the B component and the C component in advance and mixing the A component and the D component with the mixture may be used. At that time, the A component and the D component may be mixed at a temperature lower than the temperature at which the B component and the C component are mixed. This is because the B component and the C component are thereby inhibited from being separated.

Since the resin composition of the present invention contains the C component as a filler that is compatible with the B component or is dispersed in the B component, the B component and the C component are present in a region where a hard segment exists, namely, in a so-called hard segment domain, and thus damping performance can be exhibited also in the hard segment domain. In the present invention, the damping performance can be further improved by blending the D component.

The resin composition of the present invention can be molded into various shapes to be used as a shock-absorbing material. For example, the resin composition can be molded alone into a sheet by hot pressing or the like to be used as a non-constrained shock-absorbing material, or can be laminated between constraining layers that are not easily deformed to be used as a constrained shock-absorbing material. In addition, the resin composition can also be used as a paint-type resin composition and the paint-type resin composition can be applied to substrates having various shapes to form coating films, thereby being used in combination with the substrates.

### EXAMPLES

Hereinafter, the present invention will be described in more detail with reference to Examples, but the present invention is not limited to the following Examples. The part(s) indicating the used amount of each component indicates part(s) by weight.

(A Component)

(1) Methyl methacrylate-butyl acrylate-methyl Methacrylate Triblock Copolymer
KURARITY LA4285 manufactured by Kuraray Co., Ltd.

(2) Styrene-(ethylene-propylene)-styrene Block Copolymer
SEPTON 2104 manufactured by Kuraray Co., Ltd.

(B Component)

(1) Polyacrylate Modified Resin
ARUFON UP-1000 and ARUFON UP-1080 manufactured by Toagosei Co., Ltd.

(2) Naphthenic Oil
Diana Process Oil NS-100 manufactured by Idemitsu Kosan Co., Ltd.

(C Component)

(1) Rosin
PINECRYSTAL KR-85 and KR-120, which are rosin esters manufactured by Arakawa Chemical Industries, Ltd.

(2) Terpene Phenolic Resin
YS POLYSTER TH130 manufactured by Yasuhara Chemical Co., Ltd.

(3) Styrene Resin
YS RESIN SX100 manufactured by Yasuhara Chemical Co., Ltd.

(4) Hydrogenated Petroleum Resin
ARKON P-100 manufactured by Arakawa Chemical Industries, Ltd.

(D Component)

(1) Liquid Polyether Polyol
PREMINOL 54013F (polypropylene glycol) manufactured by AGC Inc.
PEG400 manufactured by Dow

(2) Silane-Modified Product of Liquid Polyether Polyol
EXCESTAR 52410 manufactured by AGC Inc.

(3) Liquid Phosphorus-Containing Polyol
Exolit OP550 manufactured by Clariant Chemicals

### Examples 1 to 2 and Comparative Examples 1 to 4

As the A component in Examples 1 to 2 and Comparative Examples 1 to 4, one in which the polymer constituting the polymer component A₁ of the A component was polymethacrylate was used. In Example 1, EXCESTAR 52410, which is a silane-modified product of a liquid polyether polyol, was used as the D component, and in Example 2, PEG400, which is a liquid polyether polyol, was used as the D component. Note that in Comparative Examples 1 and 3, the D component was not blended, and in Comparative Examples 2 and 4, the B component was not blended.

The respective components were blended on the basis of the composition given in Table 1, and kneaded with a Labo Plastomill manufactured by Toyo Seiki Seisaku-sho, Ltd., thereby providing a resin composition. This resin composition was molded using a bench press machine and a test sheet having a thickness of 200 μm was prepared. Here, in Example 1 and Comparative Examples 1 and 2, a resin composition was prepared by kneading at 180° C. and 50 rpm for 3 minutes and further kneading at 200° C. and 100 rpm for 3 minutes. In Example 2 and Comparative Examples 3 and 4, a resin composition was prepared by kneading at 180° C. and 50 rpm for 3 minutes. In Example 1 and Comparative Examples 1 and 2, test sheets having thicknesses of 100 μm and 350 μm were also prepared.

### Example 3 and Comparative Examples 5 and 6

As the A component in Example 3 and Comparative Examples 5 and 6, one in which the polymer constituting the polymer component A₁ of the A component was a styrene-based resin was used. Note that in Comparative Example 5, the D component was not blended, and in Comparative Example 6, the B component was not blended.

The respective components were blended on the basis of the composition given in Table 2, and kneaded at 200° C. and 100 rpm for 6 minutes with a Labo Plastomill manufactured by Toyo Seiki Seisaku-sho, Ltd., thereby providing a resin composition. This resin composition was molded using a bench press machine and a test sheet having a thickness of 200 μm was prepared.

(Evaluation of Shock Absorbability)

The shock acceleration was measured when a stainless steel ball (diameter: 10 mm, 4.1 kg) having a prescribed diameter was dropped from a height of 100 mm onto an acrylic plate having a size of 100×100 mm and a thickness of 30 mm. For the measurement, an acceleration sensor was attached to a back surface of the acrylic plate with an adhesive, and the measurement was performed with a handheld analyzer Model 2250 manufactured by Spectris Co., Ltd. The shock absorption performance was evaluated in terms of shock absorption rate (%). The results are given in Table 2 to 4. Here, the shock absorption rate was defined by the following equation, and the shock transmission rate (%) was calculated by dividing the acceleration when a stainless steel ball having a prescribed diameter was dropped onto the sheet by the acceleration when there was no sheet.

Shock absorption rate (%)=100(%)−shock transmission rate (%)

TABLE 1

| | | | Com- | Com- | | Com- | Com- |
|---|---|---|---|---|---|---|---|
| | | | parative | parative | | parative | parative |
| Component | Name | Example 1 | Example 1 | Example 2 | Example 2 | Example 3 | Example 4 |
| A | KURARITY LA4285 | 25 | 25 | 35 | 25 | 25 | 35 |
| A | SEPTON 2104 | — | — | — | — | — | — |
| B | ARUFON UP-1000 | 10 | 10 | — | 10 | 10 | — |
| B | Diana Process Oil NS-100 | — | — | — | — | — | — |
| C | PINECRYSTAL KR-85 | — | — | — | 5 | 5 | 5 |
| C | PINECRYSTAL KR-120 | — | — | — | — | — | — |
| C | YS POLYSTER TH130 | 5 | 5 | 5 | — | — | — |
| D | EXCESTAR S2410 | 10 | — | 10 | — | — | — |
| D | PREMINOL S4013F | — | — | — | — | — | — |
| D | PEG400 | — | — | — | 10 | — | 10 |
| Total | | 50 parts | 40 parts | 50 parts | 50 parts | 40 parts | 50 parts |
| Results | Film thickness of molded | 200 | 200 | 200 | 200 | 200 | 200 |
| | article (μm) | | | | | | |
| | Shock absorption rate (%) | 48.5 | 23.1 | 32.3 | 62.3 | 17.4 | 45.2 |

TABLE 2

| | | Example | Comparative | Comparative |
|---|---|---|---|---|
| Component | Name | 3 | Example 5 | Example 6 |
| A | KURARITY | — | — | — |
| | LA4285 | | | |
| A | SEPTON 2104 | 20 | 35 | 35 |
| B | ARUFON | — | — | — |
| | UP-1000 | | | |
| B | Diana Process Oil | 15 | 15 | — |
| | NS-100 | | | |
| C | PINECRYSTAL | — | — | — |
| | KR-85 | | | |
| C | PINECRYSTAL | 10 | 10 | 10 |
| | KR-120 | | | |
| C | YS POLYSTER | — | — | — |
| | TH130 | | | |
| D | EXCESTAR | — | — | — |
| | S2410 | | | |
| D | PREMINOL | 5 | — | 5 |
| | S4013F | | | |
| D | PEG400 | | | |
| Total | | 50 parts | 50 parts | 50 parts |
| Results | Film thickness of | 200 | 200 | 200 |
| | molded article | | | |
| | (μm) | | | |
| | Shock absorption | 40.7 | 18.2 | 30.1 |
| | rate (%) | | | |

(Results)

Examples 1 and 2 and Comparative Examples 1 to 4 are examples using an A component in which the polymer constituting the polymer component A₁ is polymethacrylate. As shown in Table 1, in Example 1, the shock absorption rate was remarkably improved to about 2.1 times as compared with Comparative Example 1 not containing the D component. As a result, it was confirmed that the resin composition of the present invention has superior damping performance even when it is thin. As shown in Comparative Example 2, when the B component was not present, the shock absorption rate was lower than that in Example 1 even when the D component was blended. As a result, it is considered that the shock absorption rate was remarkably improved owing to containing both the B component and the D component. Also in Example 2, the shock absorption rate was remarkably improved to about 3.6 times as compared with Comparative Example 3 not containing the D component. As shown in Comparative Example 4, when the B component was not present, the shock absorption rate was lower than that in Example 1 even when the D component was blended. Therefore, it is considered that the shock absorption rate was remarkably improved also in Example 2 owing to containing both the B component and the D component.

Next, Example 3 and Comparative Examples 5 and 6 are examples using an A component in which the polymer constituting the polymer component A₁ is a styrene-based resin. As shown in Table 2, in Example 3, the shock absorption rate was remarkably improved to about 2.2 times as compared with Comparative Example 5 not containing the D component. As a result, it was confirmed that the resin composition of the present invention has superior damping performance even when it is thin. As shown in Comparative Example 6, when the B component was not present, the shock absorption rate was lower than that in Example 3 even when the D component was blended. Thus, also in Example 3, it is considered that the shock absorption rate was remarkably improved owing to containing both the B component and the D component.

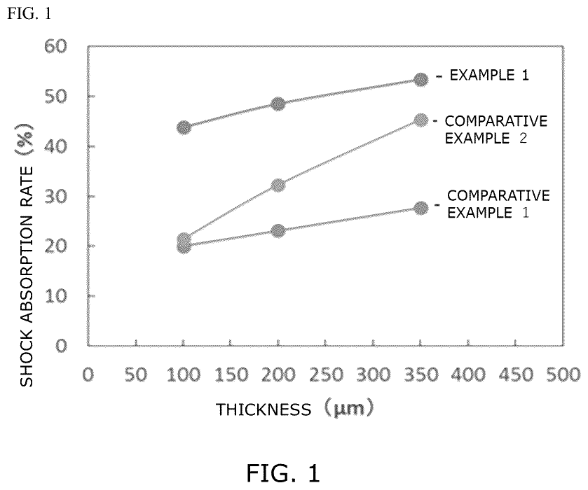

FIG. 1 is a graph showing a comparison relationship between a thickness and a shock absorption rate of a sheet made of a resin composition in Example 1, Comparative Example 1, and Comparative Example 2. This is a graph showing the relationship between the thickness and the shock absorption rate of a sheet made of a resin composition for Example 1 and Comparative Example 1. It was confirmed that Example 1 had a high shock absorption rate as compared with Comparative Example 1 even when the thickness was reduced. In addition, in Comparative Example 2, it has been found that when the thickness is reduced, the shock absorption rate tends to decrease, but in Example 1, the shock absorption rate tends not to decrease even when the thickness is reduced. Thus, it is considered that when both the B component and the D component are contained, the highest shock absorption rate can be maintained as compared with Comparative Examples 1 and 2 even if the thickness is reduced.

### Example 4 (Examples 4-1 to 4-3), Comparative Example 7 (7-1 to 7-3), and Comparative Example 8 (8-1 to 8-3)

As the A component in Example 4 and Comparative Examples 7 to 8, one in which the polymer constituting the polymer component A₁ of the A component was polymethacrylate was used. In Example 4 and Comparative Example 7, a polyacrylate resin was used as the B component. On the other hand, in Comparative Example 8, the B component was not used. In Example 4 and Comparative Examples 7 to 8, a styrene resin was used as the C component. In Example 4 and Comparative Example 8, a phosphorus-containing polyol was used as the D component. On the other hand, in Comparative Example 7, the D component was not used.

The respective components were blended on the basis of the composition given in Table 3, and kneaded with a Labo Plastomill manufactured by Toyo Seiki Seisaku-sho, Ltd., thereby providing a resin composition. This resin composition was molded using a bench press machine and test sheets having thicknesses of 100 μm, 200 μm, and 350 μm, respectively, were prepared. Note that the resin composition was prepared by kneading at 200° C. and 50 rpm for 5 minutes.

### Example 5 (Examples 5-1 to 5-3), Comparative Example 9 (9-1 to 9-3) and Comparative Example 10 (10-1 to 10-3)

As the A component in Example 5 and Comparative Examples 9 to 10, one in which the polymer constituting the polymer component A₁ of the A component was a styrene-based resin was used. In Example 5 and Comparative Example 9, naphthenic oil was used as the B component. On the other hand, in Comparative Example 10, the B component was not used. In Example 5 and Comparative Examples 9 to 10, a hydrogenated petroleum resin was used as the C component. In Example 5 and Comparative Example 10, a phosphorus-containing polyol was used as the D component. On the other hand, in Comparative Example 9, the D component was not used.

The respective components were blended on the basis of the composition given in Table 4, and kneaded with a Labo Plastomill manufactured by Toyo Seiki Seisaku-sho, Ltd., thereby providing a resin composition. This resin composition was molded using a bench press machine and test sheets having thicknesses of 100 μm, 200 μm, and 350 μm, respectively, were prepared. Note that the resin composition was prepared by kneading at 200° C. and 50 rpm for 5 minutes.

(Evaluation of Shock Absorbability)

The shock acceleration was measured when a stainless steel ball (diameter: 10 mm, 4.1 kg) having a prescribed diameter was dropped from a height of 100 mm onto an acrylic plate having a size of 100×100 mm and a thickness of 30 mm. For the measurement, an acceleration sensor was attached to a back surface of the acrylic plate with an adhesive, and the measurement was performed with a handheld analyzer Model 2250 manufactured by Spectris Co., Ltd. The shock absorption performance was evaluated in terms of shock absorption rate (%). The results are shown in Table 3 to 4. Here, the shock absorption rate was defined by the following equation, and the shock transmission rate (%) was calculated by dividing the acceleration when a stainless steel ball having a prescribed diameter was dropped onto the sheet by the acceleration when there was no sheet.

Shock absorption rate (%)=100(%)−shock transmission rate (%)

TABLE 3

| | | | | | Com- | Com- | Com- | Com- | Com- | Com- |
|---|---|---|---|---|---|---|---|---|---|---|
| | | | | | parative | parative | parative | parative | parative | parative |
| | | Exam- | Exam- | Exam- | Exam- | Exam- | Exam- | Exam- | Exam- | Exam- |
| Component | Name | ple 4-1 | ple 4-2 | ple 4-3 | ple 7-1 | ple 7-2 | ple 7-3 | ple 8-1 | ple 8-2 | ple 8-3 |
| A | KURARITY LA4285 | 35 | 35 | 35 | 35 | 35 | 35 | 42 | 42 | 42 |
| A | SEPTON 2104 | | | | | | | | | |
| B | ARUFON UP-1000 | 7 | 7 | 7 | 7 | 7 | 7 | | | |
| B | Diana Process | | | | | | | | | |
| | Oil NS-100 | | | | | | | | | |
| C | YS RESIN SX100 | 14 | 14 | 14 | 14 | 14 | 14 | 14 | 14 | 14 |
| C | ARKON P-100 | | | | | | | | | |
| D | Exolit OP550 | 14 | 14 | 14 | | | | 14 | 14 | 14 |
| Total (parts by weight) | | 70 | 70 | 70 | 56 | 56 | 56 | 70 | 70 | 70 |
| Film thickness of molded | | 100 | 200 | 350 | 100 | 200 | 350 | 100 | 200 | 350 |
| article (μm) | | | | | | | | | | |
| Results | Shock absorption | 31 | 35 | 40 | 27 | 31 | 35 | 14 | 17 | 21 |
| | rate (%) | | | | | | | | | |

TABLE 4

| | | | | | Com- | Com- | Com- | Com- | Com- | Com- |
|---|---|---|---|---|---|---|---|---|---|---|
| | | | | | parative | parative | parative | parative | parative | parative |
| | | Exam- | Exam- | Exam- | Exam- | Exam- | Exam- | Exam- | Exam- | Exam- |
| Component | Name | ple 5-1 | ple 5-2 | ple 5-3 | ple 9-1 | ple 9-2 | ple 9-3 | ple 10-1 | ple10-2 | ple 10-3 |
| A | KURARITY LA4285 | | | | | | | | | |
| A | SEPTON 2104 | 35 | 35 | 35 | 35 | 35 | 35 | 42 | 42 | 42 |
| B | ARUFON UP-1000 | | | | | | | | | |
| B | Diana Process Oil NS-100 | 7 | 7 | 7 | 7 | 7 | 7 | | | |
| C | YS RESIN SX100 | | | | | | | | | |
| C | ARKON P-100 | 14 | 14 | 14 | 14 | 14 | 14 | 14 | 14 | 14 |
| D | Exolit OP550 | 14 | 14 | 14 | | | | 14 | 14 | 14 |
| Total (parts by weight) | | 70 | 70 | 70 | 56 | 56 | 56 | 70 | 70 | 70 |
| Film thickness of | | 100 | 200 | 350 | 100 | 200 | 350 | 100 | 200 | 350 |
| molded article (μm) | | | | | | | | | | |
| Results | Shock absorption | 30 | 35 | 39 | 26 | 29 | 33 | 12 | 14 | 17 |
| | rate (%) | | | | | | | | | |

(Results)

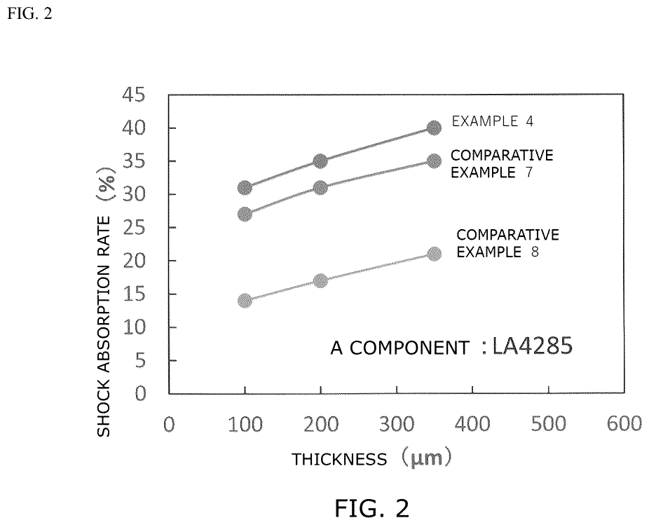

Example 4, Comparative Example 7, and Comparative Example 8 are examples using an A component in which the polymer constituting the polymer component A₁ is polymethacrylate. As shown in Table 3, Example 4 is based on a molded article comprising the A, B, C and D components. Comparative Example 7 is based on a molded article containing the A, B and C components but not containing the D component. Comparative Example 8 is based on a molded article containing the A, C and D components but not containing the B component. In view of Table 3 and FIG. 2, comparing Example 4 with Comparative Example 8, it was found that when the film thickness of the molded article was 200 μm, the shock absorption rate in Example 4 was about 2.1 times higher as compared with Comparative Example 8 not containing the B component. When Comparative Example 7 was compared with Comparative Example 8, it was found that when the film thickness of the molded article was 200 μm, the shock absorption rate in Comparative Example 7 was about 1.8 times higher as compared with Comparative Example 8 not containing the B component. From the above facts, it was found that the B component greatly contributes to an improvement of the shock absorption rate.

When Example 4 was compared with Comparative Example 7, it was found that the shock absorption rate in Example 4 was further improved to about 1.13 times as compared with Comparative Example 7 not containing the D component. From the above fact, it was found that not only the B component but also the D component greatly contributes to further improving and securing the shock absorption rate.

As can be seen from FIG. 2, in Example 4, it was confirmed that a shock absorption rate of about 30% can be secured even when the thickness is reduced to 100 μm as compared with Comparative Examples 7 and 8. Thus, it is considered that when both the B component and the D component are contained, the highest shock absorption rate can be maintained as compared with Comparative Examples 7 and 8 even if the thickness is reduced.

(Results)

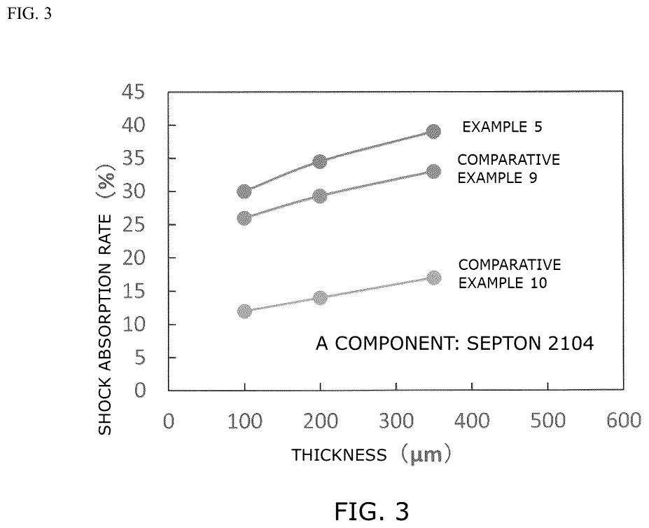

Example 5 and Comparative Examples 9 and 10 are examples using an A component in which the polymer constituting the polymer component A₁ is a styrene resin. As shown in Table 4, Example 5 is based on a molded article comprising the A, B, C and D components. Comparative Example 9 is based on a molded article containing the A, B and C components but not containing the D component. Comparative Example 10 is based on a molded article containing the A, C and D components but not containing the B component. In view of Table 4 and FIG. 3, comparing Example 5 with Comparative Example 10, it was found that when the film thickness of the molded article was 200 μm, the shock absorption rate in Example 5 was about 2.5 times higher as compared with Comparative Example 10 not containing the B component. When Comparative Example 9 was compared with Comparative Example 10, it was found that when the film thickness of the molded article was 200 μm, the shock absorption rate in Comparative Example 9 was about 2.1 times higher as compared with Comparative Example 10 not containing the B component. From the above facts, it was found that the B component greatly contributes to the improvement of the shock absorption rate.

Further, when Example 5 was compared with Comparative Example 9, it was found that the shock absorption rate in Example 5 was further improved to about 1.2 times as compared with Comparative Example 9 not containing the D component. From the above fact, it was found that not only the B component but also the D component greatly contributes to further improving and securing the shock absorption rate.

In addition, as can be seen from FIG. 3, in Example 5, it was confirmed that a shock absorption rate of about 30% can be secured even when the thickness is reduced to 100 μm as compared with Comparative Examples 9 and 10. Thus, it is considered that when both the B component and the D component are contained, the highest shock absorption rate can be maintained as compared with Comparative Examples 9 and 10 even if the thickness is reduced.

### INDUSTRIAL APPLICABILITY

Since the shock absorption-resin composition of the present invention has superior damping performance even when it is thinned, it can be suitably used not only in a shock-absorbing sheet for a device but also in other applications where vibration and noise are problems.

What is claimed is:

1. A shock absorption-resin composition comprising:
an A component comprising one or more block copolymers each comprising a polymer component A₁ having a glass transition point of 30° C. or higher and a polymer component A₂ having a glass transition point of 0° C. or lower;
a B component comprising a polymer compatible with the polymer component A₁;
a C component comprising a filler compatible with the B component or dispersible in the B component; and
a D component comprising a liquid polyol-based component.

2. The shock absorption-resin composition according to claim 1, wherein the liquid polyol-based component comprises one or more selected from the group consisting of a liquid polyether polyol, a liquid polyester polyol, a copolymer of the polyether polyol and the polyester polyol, and a modified product of at least one among the liquid polyether polyol, the liquid polyester polyol, and the copolymer.

3. The shock absorption-resin composition according to claim 2, wherein the modified product is at least one selected from the group consisting of a silyl group-containing polyol, a phosphorus-containing polyol, a halogen-containing polyol, and a polar group-containing polyol.

4. The resin composition according to claim 1, wherein a ratio of the A component is 1 to 99% by weight of the entire resin composition.

5. The resin composition according to claim 1, wherein the polymer component A₁ is one selected from the group consisting of a styrene-based resin, a poly(meth)acrylate resin, a polyamide resin, and a polyester resin.

6. The resin composition according to claim 5, wherein the polymer component A₁ is a styrene-based resin, and the B component is one selected from the group consisting of an aromatic hydrocarbon resin, a hydrogenated product of an aromatic hydrocarbon resin, an alicyclic hydrocarbon resin, and a copolymerized resin thereof.

7. The resin composition according to claim 5, wherein the polymer component A₁ is a poly(meth)acrylate resin, and the B component is an aliphatic hydrocarbon resin.

8. The resin composition according to claim 7, wherein the aliphatic hydrocarbon resin is a poly(meth)acrylate resin having a molecular weight of 10,000 or less.

9. The resin composition according to claim 5, wherein the polymer component A₁ is a poly(meth)acrylate resin, and the B component is an aromatic hydrocarbon resin or a hydrogenated product of an aromatic hydrocarbon resin.

10. The resin composition according to claim 1, wherein the C component is a compound having two or more cyclic structures selected from the group consisting of an aromatic hydrocarbon, an aliphatic cyclic hydrocarbon, and a heteroaromatic hydrocarbon, or a metal salt of the compound.
